(19) United States
(12) Patent Application Publication
(10) Pub. No.: US 2026/0238522 A1
(43) Pub. Date: Aug. 13, 2026

(54) DECISION FEEDBACK EQUALIZER WITH LOWER POWER CONSUMPTION AND HIGH SPEED

(71) Applicant: MEDIATEK INC., Hsinchu City (TW)

(72) Inventors: Tse-Hsiang Hsu, Hsinchu City (TW); Hsin-Kuang Chen, Hsinchu City (TW)

(73) Assignee: MEDIATEK INC., Hsinchu City (TW)

(21) Appl. No.: 19/433,940

(22) Filed: Dec. 28, 2025

Related U.S. Application Data
(60) Provisional application No. 63/756,274, filed on Feb. 10, 2025.

(51) Int. Cl. H04L 25/03

(52) U.S. Cl. CPC H04L 25/03057; H04L 2025/0349

(57) ABSTRACT

The present invention provides an equalizer including a summer, a first processing circuit, a second processing circuit and a DAC. The summer is configured to combine an input signal with a feedback signal to generate a compensated input signal. The first processing circuit includes a first summer, a first slicer, a second summer and a second slicer. The first summer is configured to combine a first reference signal with a second signal to generate an adjusted first reference signal, for the first slicer to generate a first output signal. The second summer is configured to combine a second reference signal with the second signal to generate an adjusted second reference signal, for the second slicer to generate a second output signal. The second processing circuit receives the compensated signal to generate a third output signal and a fourth output signal, for the DAC to generate the second signal.

### CROSS REFERENCE TO RELATED APPLICATIONS

This application claims the benefit of U.S. Provisional Application No. 63/756,274, filed on Feb. 10th, 2025. The content of the application is incorporated herein by reference.

### BACKGROUND

In modern high-speed communication systems, data signals are often transmitted over channels that introduce inter-symbol interference (ISI). ISI occurs when a transmitted symbol spreads into subsequent symbol intervals, causing distortion and making it difficult for a receiver to correctly distinguish between different transmitted symbols. To mitigate the effects of ISI and reliably recover the transmitted data, various equalization techniques are employed. Among these, the Decision Feedback Equalizer (DFE) is a widely utilized non-linear equalizer known for its ability to effectively suppress post-cursor ISI without amplifying noise, unlike linear equalizers.

Conventional DFE architectures suffer from several inherent disadvantages that limit their performance, particularly as data rates continue to increase: the increased power consumption and circuit mismatch due to multiple current mode logic (CML) summers, DFE speed is limited due to heavy load at the summer, and large power consumption and chip area in DFE with loop-unrolled structure.

Therefore, there is a continuing need in the art for an improved DFE architecture that addresses these limitations, offering higher speed, lower power consumption, and reduced chip area without compromising equalization performance.

### SUMMARY

Therefore, one of the objects of present invention is to provide a DFE, which has less slicers and separated summers, to solve the above-mentioned problems.

According to one embodiment of the present invention, an equalizer comprising a summer, a first processing circuit, a second processing circuit and a DAC is disclosed. The summer is configured to combine an input signal with a feedback signal to generate a compensated input signal. The first processing circuit comprises a first summer, a first slicer, a second summer and a second slicer. The first summer is configured to combine a first reference signal with a second signal to generate an adjusted first reference signal. The first slicer is configured to compare the compensated input signal with the adjusted first reference signal to generate a first output signal. The second summer is configured to combine a second reference signal with the second signal to generate an adjusted second reference signal. The second slicer is configured to compare the compensated input signal with the adjusted second reference signal to generate a second output signal. The second processing circuit is configured to receive the compensated signal to generate a third output signal and a fourth output signal. The DAC is configured to perform a digital-to-analog conversion operation on the third output signal and the fourth output signal to generate the second signal.

According to one embodiment of the present invention, an equalizer comprising a summer, a first processing circuit, a second processing circuit, a third processing circuit, a fourth processing circuit and a DAC is disclosed. The summer is configured to combine an input signal with a feedback signal to generate a compensated input signal. The first processing circuit comprises a first summer, a first slicer, a second summer and a second slicer. The first summer is configured to combine a first reference signal with a second signal to generate an adjusted first reference signal. The first slicer is configured to compare the compensated input signal with the adjusted first reference signal to generate a first output signal. The second summer is configured to combine a second reference signal with the second signal to generate an adjusted second reference signal. The second slicer is configured to compare the compensated input signal with the adjusted second reference signal to generate a second output signal. The second processing circuit is configured to receive the compensated signal to generate a third output signal and a fourth output signal. The third processing circuit is configured to receive the compensated signal to generate a fifth output signal and a sixth output signal. The fourth processing circuit is configured to receive the compensated signal to generate a seventh output signal and an eighth output signal. The DAC is configured to perform a digital-to-analog conversion operation on the seventh output signal and the eighth output signal.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a diagram illustrating an equalizer according to one embodiment of the present invention.

FIG. 2 is a diagram illustrating a summer combining the first reference signal and the AC-coupled signal according to one embodiment of the present invention.

FIG. 3 is a diagram illustrating a summer combining the first reference signal and the AC-coupled signal according to one embodiment of the present invention.

FIG. 4 is a diagram illustrating a diagram illustrating part of an equalizer according to one embodiment of the present invention.

FIG. 5 is a diagram illustrating a processing circuit according to one embodiment of the present invention.

### DETAILED DESCRIPTION

Certain terms are used throughout the following description and claims to refer to particular system components. As one skilled in the art will appreciate, manufacturers may refer to a component by different names. This document does not intend to distinguish between components that differ in name but not function. In the following discussion and in the claims, the terms “including” and “comprising” are used in an open-ended fashion, and thus should be interpreted to mean “including, but not limited to …”. The terms “couple” and “couples” are intended to mean either an indirect or a direct electrical connection. Thus, if a first device couples to a second device, that connection may be through a direct electrical connection, or through an indirect electrical connection via other devices and connections.

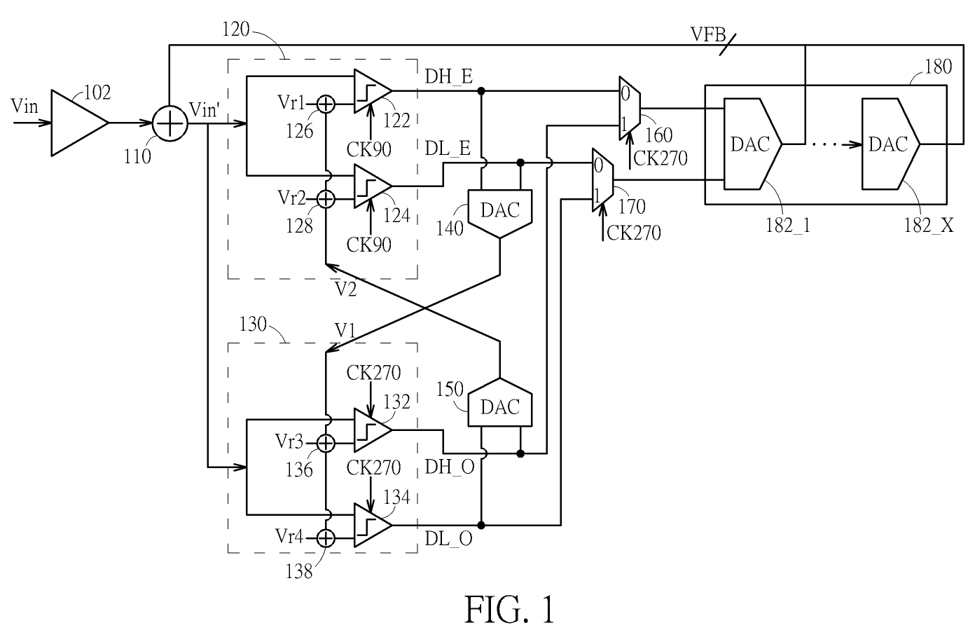

FIG. 1 is a diagram illustrating a diagram illustrating an equalizer 100 according to one embodiment of the present invention. In this embodiment, without a limitation of the present invention, the equalizer 100 is a half-rate decision feedback equalizer. As shown in FIG. 1, the equalizer 100 comprises a buffer 102, a summer 110, a first processing circuit 120, a second processing circuit 130, a digital-to-analog converter (DAC) 140, a DAC 150, multiplexers 160, 170, and a feedback signal generation circuit 180. The first processing circuit 120 comprises slicers 122, 124, and summers 126, 128. The second processing circuit 130 comprises slicers 132, 134, and summers 136, 138. The feedback signal generation circuit 180 comprises multiple DACs 182_1 – 182_Xcorresponding to different taps of the equalizer 100, for example, the DACs 140 and 150 correspond to the first tap, the DAC 182_1 corresponds to the second tap, and the DAC 182_X corresponds to the (X+1)^{th} tap, wherein ”X” can be any suitable positive integer.

The buffer 102 receives an input signal Vin, and the summer 110 combines the input signal Vin with a feedback signal VFB generated by the feedback signal generation circuit 180 to generate a compensated input signal Vin’. In this embodiment, the summer 110 is implemented by a current mode logic (CML) summer, and the feedback signal VFB may comprise multiple signals generated according to the outputs of the DACs 182_1 – 182_X and corresponding weights.

The first processing circuit 120 can be regarded as an even channel of the half-rate decision feedback equalizer. In the first processing circuit 120, the summer 126 combines a first reference signal Vr1 with a second signal V2 to generate an adjusted first reference signal, wherein the first reference signal Vr1 may be a reference voltage, and the second signal V2 is generated by the DAC 150. The slicer 122 compares the compensated input signal Vin’ with the adjusted first reference signal to generate an output signal DH_E. In this embodiment, if the compensated input signal Vin’ is greater than the adjusted first reference signal, the output signal DH_E has a high voltage level corresponding to logical value “1”; and if the compensated input signal Vin’ is not greater than the adjusted first reference signal, the output signal DH_E has a low voltage level corresponding to logical value “0”. The summer 128 combines a second reference signal Vr2 with the second signal V2 to generate an adjusted second reference signal, wherein the second reference signal Vr2 may be a reference voltage which is lower than the first reference signal Vr1. The slicer 124 compares the compensated input signal Vin’ with the adjusted second reference signal to generate an output signal DL_E. In this embodiment, if the compensated input signal Vin’ is greater than the adjusted second reference signal, the output signal DL_E has a high voltage level corresponding to logical value “1”; and if the compensated input signal Vin’ is not greater than the adjusted second reference signal, the output signal DL_E has a low voltage level corresponding to logical value “0”.

In this embodiment, the slicers 122 and 124 generate the output signals DH_E and DL_E based on a clock signal CK90. For example, the slicers 122 and 124 start to generate the output signals DH_E and DL_E at an edge (e.g., rising edge) of the clock signal CK90.

The second processing circuit 130 can be regarded as an odd channel of the half-rate decision feedback equalizer. In the second processing circuit 130, the summer 136 combines a third reference signal Vr3 with a first signal V1 to generate an adjusted third reference signal, wherein the third reference signal Vr3 may be a reference voltage, and the first signal V1 is generated by the DAC 140. The slicer 132 compares the compensated input signal Vin’ with the adjusted third reference signal to generate an output signal DH_O. In this embodiment, if the compensated input signal Vin’ is greater than the adjusted third reference signal, the output signal DH_O has a high voltage level corresponding to logical value “1”; and if the compensated input signal Vin’ is not greater than the adjusted third reference signal, the output signal DH_O has a low voltage level corresponding to logical value “0”. The summer 138 combines a fourth reference signal Vr4 with the first signal V1 to generate an adjusted fourth reference signal, wherein the fourth reference signal Vr4 may be a reference voltage which is lower than the third reference signal Vr3. The slicer 134 compares the compensated input signal Vin’ with the adjusted fourth reference signal to generate an output signal DL_O. In this embodiment, if the compensated input signal Vin’ is greater than the adjusted fourth reference signal, the output signal DL_O has a high voltage level corresponding to logical value “1”; and if the compensated input signal Vin’ is not greater than the adjusted fourth reference signal, the output signal DL_O has a low voltage level corresponding to logical value “0”.

In one embodiment, the first reference signal Vr1 is equal to the third reference signal Vr3, and the second reference signal Vr2 is equal to the fourth reference signal Vr4. That is, the first reference signal Vr1 and the third reference signal Vr3 have the same voltage level, and the second reference signal Vr2 and the fourth reference signal Vr4 have the same voltage level.

In this embodiment, the slicers 132 and 134 generate the output signals DH_O and DL_O based on a clock signal CK270. For example, the slicers 132 and 134 start to generate the output signals DH_O and DL_O at an edge (e.g., rising edge) of the clock signal CK270.

In this embodiment, the clock signals CK90 and CK270 have the same frequency but are 180 degrees out of phase. Specifically, clock signal CK90 can be generated by delaying an original clock signal by 90 degrees of phase, and clock signal CK270 can be generated by delaying the original clock signal by 270 degrees of phase.

The DAC 140 performs digital-to-analog conversion operation on the output signals DH_E and DL_E to generate the first signal V1, and the DAC 140 serves as a first tap DAC configured to generate the first signal V1 for cancelling first post-cursor ISI. Similarly, the DAC 150 performs digital-to-analog conversion operation on the output signals DH_O and DL_O to generate the second signal V2, and the DAC 150 also serves as a first tap DAC configured to generate the second signal V2 for cancelling first post-cursor ISI.

The multiplexer 160 is configured to output one of the output signals DH_E and DH_O according to the clock signal CK270 or any other suitable clock signal. For example, when the clock signal CK270 has a low voltage level, the multiplexer 160 outputs the output signals DH_E generated by the slicer 122; and when the clock signal CK270 has a high voltage level, the multiplexer 160 outputs the output signals DH_O generated by the slicer 132.

The multiplexer 170 is configured to output one of the output signals DL_E and DL_O according to the clock signal CK270 or any other suitable clock signal. For example, when the clock signal CK270 has a low voltage level, the multiplexer 170 outputs the output signals DL_E generated by the slicer 124; and when the clock signal CK270 has a high voltage level, the multiplexer 170 outputs the output signals DL_O generated by the slicer 134.

The feedback signal generation circuit 180 is configured to receive multiplexer output signals generated by the multiplexer 160 and 170 to generate the feedback signal VFB, for cancelling post-cursor ISI. It is noted that since the operation of the feedback signal generation circuit 180 is known by a person skilled in the art, detailed descriptions of feedback signal generation circuit 180 are omitted here.

In the embodiment shown in FIG. 1, by using the equalizer 100 of the present invention, desired performance can be achieved with fewer slicers. This consequently reduces power consumption and chip area compared to prior art equalizers employing a loop-unrolled architecture. In addition, by using separate summers 126, 128, 136 and 138 in the first processing circuit 120 and second processing circuit 130 (i.e., these summers are distinct summers), the loading on each summer is reduced, thereby enabling support for higher-speed applications.

In one embodiment, the equalizer 100 has only one summer 110 for generating the compensated input signal Vin’ to the first processing circuit 120 and second processing circuit 130. This design can lower the power consumption and avoid the circuit mismatch issue of prior art.

It is noted that quantity of the slicers within the first processing circuit 120 or the second processing circuit 130 is for illustrative purposes, not a limitation of the present invention. In other embodiment, the first processing circuit 120 or the second processing circuit 130 may have more than two slicers, and these slicers are configured to compare the compensated input signal Vin’ with different reference voltages to generate the output signals. These alternative designs shall fall within the scope of the present invention.

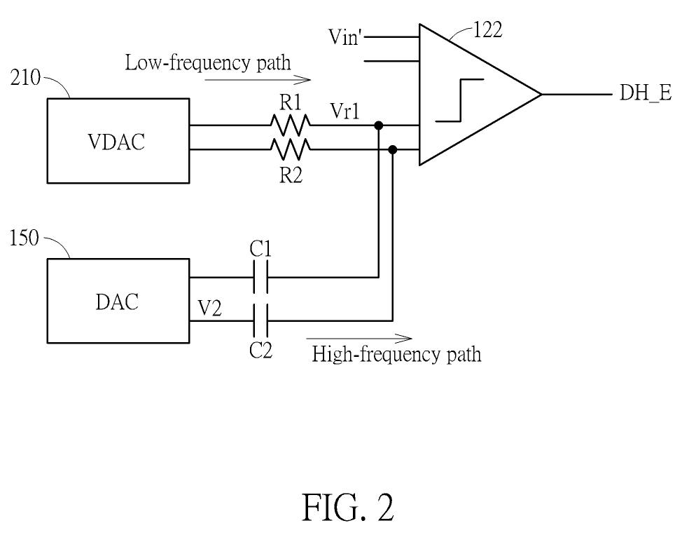

In one embodiment, the first signal V1 and the second signal V2 may be AC-coupled signal, for the summers 126, 128, 136 and 138 to generate the adjusted first reference signal, adjusted second reference signal, adjusted third reference signal and adjusted fourth reference signal. Taking the summer 126 shown in FIG. 2 as an example, a voltage-DAC 210 generates the first reference voltage Vr1 through resistors R1 and R2, and the second voltage V2 generated by the DAC 150 passes through capacitors C1 and C2 to form an AC-coupled signal. The first reference voltage Vr1 and the AC-coupled signal are combined at nodes to generate the adjusted first reference signal, wherein the nodes serve as the summer 126. In the embodiment shown in FIG. 2, the resistors R1 and R2 form a low-frequency path, and the capacitors C1 and C2 form a high-frequency path. In addition, the embodiment in FIG. 2 shows a differential structure while FIG. 1 shows a single-ended structure.

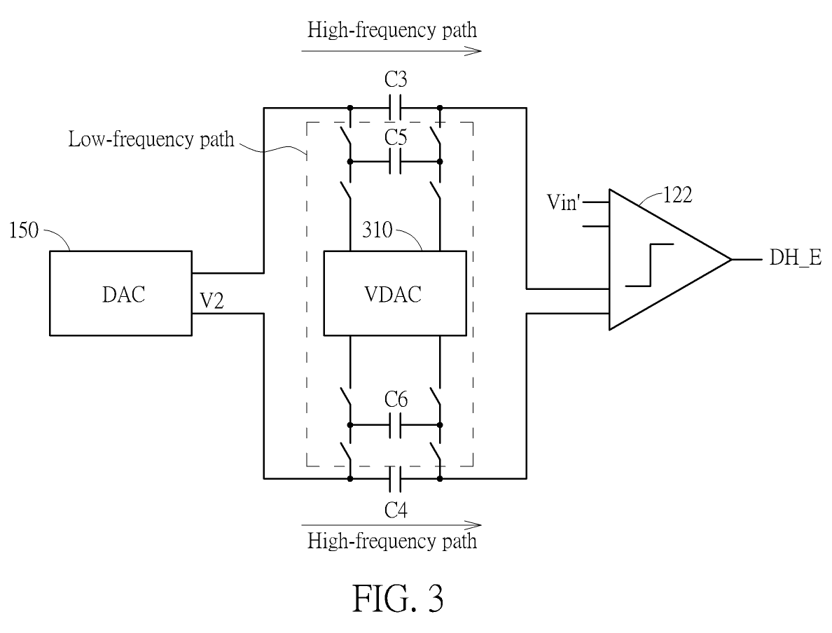

Taking the summer 126 shown in FIG. 3 as another example, a voltage-DAC 310 generates the first reference voltage Vr1 through switched capacitors C5 and C6, and the second voltage V2 generated by the DAC 150 passes through capacitors C3 and C4 to form an AC-coupled signal. The first reference voltage Vr1 and the AC-coupled signal are combined at nodes to generate the adjusted first reference signal, wherein the nodes serve as the summer 126. In the embodiment shown in FIG. 3, the switched capacitors C5 and C6 form a low-frequency path, and the capacitors C3 and C4 form a high-frequency path. In addition, the embodiment in FIG. 3 shows a differential structure while FIG. 1 shows a single-ended structure.

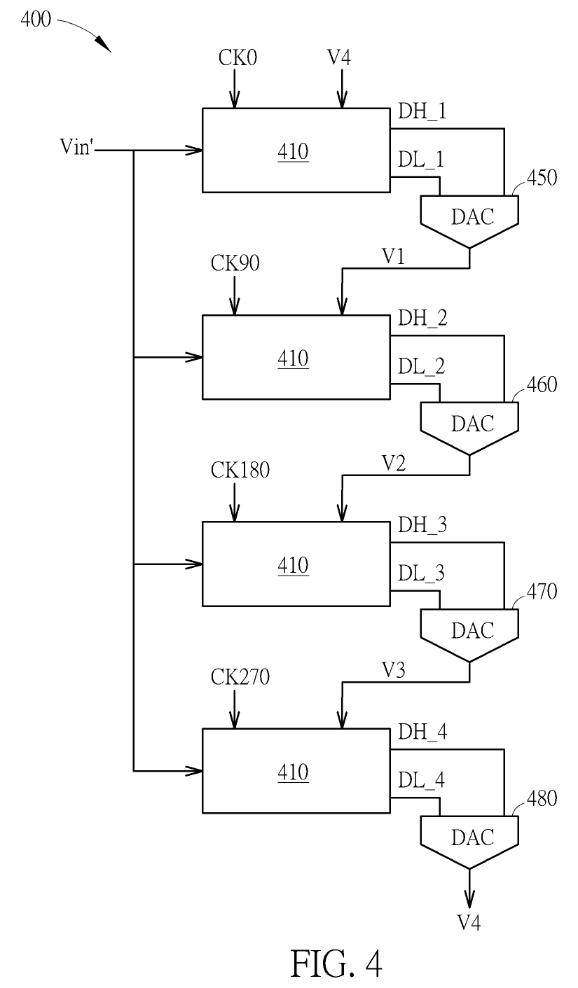

In another embodiment, the first processing circuit 120, second processing circuit 130, DAC 140 and DAC 150 shown in FIG. 1 can be replaced by a circuitry 400 shown in FIG. 4, for implementing a quarter-rate decision feedback equalizer. As shown in FIG. 4, the circuitry 400 comprises a first processing circuit 410, a second processing circuit 420, a third processing circuit 430, a fourth processing circuit 440, and multiple DACs 450, 460, 470 and 480.

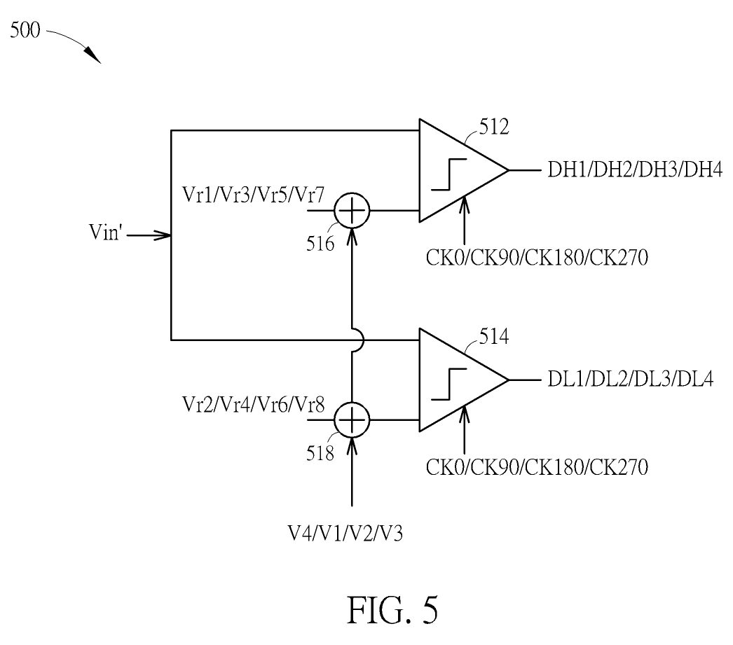

Regarding the operation of the circuitry 400, refer to a processing circuit 500 shown in FIG. 5 together, wherein the processing circuit 500 can be used to implement any one of the first processing circuit 410, second processing circuit 420, third processing circuit 430 and fourth processing circuit 440. Specifically, the first processing circuit 410 can be regarded as a first channel of the quarter-rate decision feedback equalizer. In the first processing circuit 410, the summer 516 combines a first reference signal Vr1 with a fourth signal V4 to generate an adjusted first reference signal, wherein the first reference signal Vr1 may be a reference voltage, and the fourth signal V4 is generated by the DAC 480. The slicer 512 compares the compensated input signal Vin’ with the adjusted first reference signal to generate an output signal DH_1. In this embodiment, if the compensated input signal Vin’ is greater than the adjusted first reference signal, the output signal DH_1 has a high voltage level corresponding to logical value “1”; and if the compensated input signal Vin’ is not greater than the adjusted first reference signal, the output signal DH_1 has a low voltage level corresponding to logical value “0”. The summer 518 combines a second reference signal Vr2 with the fourth signal V4 to generate an adjusted second reference signal, wherein the second reference signal Vr2 may be a reference voltage which is lower than the first reference signal Vr1. The slicer 514 compares the compensated input signal Vin’ with the adjusted second reference signal to generate an output signal DL_1. In this embodiment, if the compensated input signal Vin’ is greater than the adjusted second reference signal, the output signal DL_1 has a high voltage level corresponding to logical value “1”; and if the compensated input signal Vin’ is not greater than the adjusted second reference signal, the output signal DL_1 has a low voltage level corresponding to logical value “0”.

In this embodiment, the slicers 512 and 514 positioned in the first processing circuit 410 generate the output signals DH_1 and DL_1 based on a clock signal CK0. For example, the slicers 512 and 514 start to generate the output signals DH_1 and DL_1 at an edge (e.g., rising edge) of the clock signal CK0.

The second processing circuit 420 can be regarded as a second channel of the quarter-rate decision feedback equalizer. In the second processing circuit 420, the summer 516 combines a third reference signal Vr3 with a first signal V1 to generate an adjusted third reference signal, wherein the third reference signal Vr3 may be a reference voltage, and the first signal V1 is generated by the DAC 450. The slicer 512 compares the compensated input signal Vin’ with the adjusted third reference signal to generate an output signal DH_2. In this embodiment, if the compensated input signal Vin’ is greater than the adjusted third reference signal, the output signal DH_2 has a high voltage level corresponding to logical value “1”; and if the compensated input signal Vin’ is not greater than the adjusted third reference signal, the output signal DH_2 has a low voltage level corresponding to logical value “0”. The summer 518 combines a fourth reference signal Vr4 with the first signal V1 to generate an adjusted fourth reference signal, wherein the fourth reference signal Vr4may be a reference voltage which is lower than the third reference signal Vr3. The slicer 514 compares the compensated input signal Vin’ with the adjusted fourth reference signal to generate an output signal DL_2. In this embodiment, if the compensated input signal Vin’ is greater than the adjusted fourth reference signal, the output signal DL_2 has a high voltage level corresponding to logical value “1”; and if the compensated input signal Vin’ is not greater than the adjusted fourth reference signal, the output signal DL_2 has a low voltage level corresponding to logical value “0”.

In this embodiment, the slicers 512 and 514 positioned in the second processing circuit 420 generate the output signals DH_2 and DL_2 based on a clock signal CK90. For example, the slicers 512 and 514 start to generate the output signals DH_2 and DL_2 at an edge (e.g., rising edge) of the clock signal CK90.

The third processing circuit 430 can be regarded as a third channel of the quarter-rate decision feedback equalizer. In the third processing circuit 430, the summer 516 combines a fifth reference signal Vr5 with a second signal V2 to generate an adjusted fifth reference signal, wherein the fifth reference signal Vr5 may be a reference voltage, and the second signal V2 is generated by the DAC 460. The slicer 512 compares the compensated input signal Vin’ with the adjusted fifth reference signal to generate an output signal DH_3. In this embodiment, if the compensated input signal Vin’ is greater than the adjusted fifth reference signal, the output signal DH_3 has a high voltage level corresponding to logical value “1”; and if the compensated input signal Vin’ is not greater than the adjusted fifth reference signal, the output signal DH_3 has a low voltage level corresponding to logical value “0”. The summer 518 combines a sixth reference signal Vr6 with the second signal V2 to generate an adjusted sixth reference signal, wherein the sixth reference signal Vr6 may be a reference voltage which is lower than the fifth reference signal Vr5. The slicer 514 compares the compensated input signal Vin’ with the adjusted sixth reference signal to generate an output signal DL_3. In this embodiment, if the compensated input signal Vin’ is greater than the adjusted sixth reference signal, the output signal DL_3 has a high voltage level corresponding to logical value “1”; and if the compensated input signal Vin’ is not greater than the adjusted sixth reference signal, the output signal DL_3 has a low voltage level corresponding to logical value “0”.

In this embodiment, the slicers 512 and 514 positioned in the third processing circuit 430 generate the output signals DH_3 and DL_3 based on a clock signal CK180. For example, the slicers 512 and 514 start to generate the output signals DH_3 and DL_3 at an edge (e.g., rising edge) of the clock signal CK180.

The fourth processing circuit 440 can be regarded as a fourth channel of the quarter-rate decision feedback equalizer. In the fourth processing circuit 440, the summer 516 combines a seventh reference signal Vr7 with a third signal V3 to generate an adjusted seventh reference signal, wherein the seventh reference signal Vr7 may be a reference voltage, and the third signal V3 is generated by the DAC 470. The slicer 512 compares the compensated input signal Vin’ with the adjusted seventh reference signal to generate an output signal DH_4. In this embodiment, if the compensated input signal Vin’ is greater than the adjusted seventh reference signal, the output signal DH_4 has a high voltage level corresponding to logical value “1”; and if the compensated input signal Vin’ is not greater than the adjusted seventh reference signal, the output signal DH_4 has a low voltage level corresponding to logical value “0”. The summer 518 combines an eighth reference signal Vr8 with the third signal V3 to generate an adjusted eighth reference signal, wherein the eighth reference signal Vr8 may be a reference voltage which is lower than the seventh reference signal Vr7. The slicer 514 compares the compensated input signal Vin’ with the adjusted eighth reference signal to generate an output signal DL_4. In this embodiment, if the compensated input signal Vin’ is greater than the adjusted eighth reference signal, the output signal DL_4 has a high voltage level corresponding to logical value “1”; and if the compensated input signal Vin’ is not greater than the adjusted eighth reference signal, the output signal DL_4 has a low voltage level corresponding to logical value “0”.

In this embodiment, the slicers 512 and 514 positioned in the fourth processing circuit 440 generate the output signals DH_4 and DL_4 based on a clock signal CK270. For example, the slicers 512 and 514 start to generate the output signals DH_4 and DL_4 at an edge (e.g., rising edge) of the clock signal CK270.

In one embodiment, the first reference signal Vr1 is equal to each of the third reference signal Vr3, the fifth reference signal Vr5 and the seventh reference signal Vr7, and the second reference signal Vr2 is equal to each of the fourth reference signal Vr4, the sixth reference signal Vr6 and the eighth reference signal Vr8. That is, the first reference signal Vr1, the third reference signal Vr3, the fifth reference signal Vr5 and the seventh reference signal Vr7 have the same voltage level; and the second reference signal Vr2, the fourth reference signal Vr4, the sixth reference signal Vr6and the eighth reference signal Vr8 have the same voltage level.

In this embodiment, the clock signals CK0, CK90, CK180 and CK270 have the same frequency but different phases. Specifically, clock signal CK90 can be generated by delaying an original clock signal (e.g., CK0) by 90 degrees of phase, and clock signal CK180 can be generated by delaying the original clock signal by 180 degrees of phase, and clock signal CK270 can be generated by delaying the original clock signal by 270 degrees of phase.

The DAC 450 performs digital-to-analog conversion operation on the output signals DH_1 and DL_1 to generate the first signal V1, and the DAC 450 serves as a first tap DAC configured to generate the first signal V1 for cancelling first post-cursor ISI. Similarly, the DAC 460 performs digital-to-analog conversion operation on the output signals DH_2 and DL_2 to generate the second signal V2, the DAC 470 performs digital-to-analog conversion operation on the output signals DH_3 and DL_3 to generate the third signal V3, and the DAC 480 performs digital-to-analog conversion operation on the output signals DH_4 and DL_4 to generate the fourth signal V4, for cancelling first post-cursor ISI.

When the equalizer 100 is modified to use the circuitry 400, the multiplexer 160 is configured to output one of the output signals DH_1, DH_2, DH_3 and DH_4 according to a suitable clock signal. Similarly, the multiplexer 170 is configured to output one of the output signals DL_1, DL_2, DL_3 and DL_4 according to a suitable clock signal.

Briefly summarized, by designing separate summers for adjusting the reference signals to generate adjusted reference signals, for use by the slicers, the loading on each summer is reduced, thereby enabling support for higher-speed applications. In addition, by designing only one summer for generating the compensated input signal Vin’ to all the slicers, the power consumption is reduced, the circuit mismatch issue can be avoided.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An equalizer, comprising:
a summer, configured to combine an input signal with a feedback signal to generate a compensated input signal;
a first processing circuit comprising:
a first summer, configured to combine a first reference signal with a second signal to generate an adjusted first reference signal;
a first slicer, configured to compare the compensated input signal with the adjusted first reference signal to generate a first output signal;
a second summer, configured to combine a second reference signal with the second signal to generate an adjusted second reference signal; and
a second slicer, configured to compare the compensated input signal with the adjusted second reference signal to generate a second output signal;
a second processing circuit, configured to receive the compensated signal to generate a third output signal and a fourth output signal; and
a digital-to-analog converter (DAC), configured to perform a digital-to-analog conversion operation on the third output signal and the fourth output signal to generate the second signal.

2. The equalizer of claim 1, wherein the second signal is an AC-coupled signal.

3. The equalizer of claim 1, wherein the summer is a current mode logic (CML) summer.

4. The equalizer of claim 1, wherein the second processing circuit comprises:
a third summer, configured to combine a third reference signal with a first signal to generate an adjusted third reference signal;
a third slicer, configured to compare the compensated input signal with the adjusted third reference signal to generate the third output signal;
a fourth summer, configured to combine a fourth reference signal with the first signal to generate an adjusted fourth reference signal; and
a fourth slicer, configured to compare the compensated input signal with the adjusted fourth reference signal to generate the fourth output signal;
wherein the DAC is a second DAC, and the equalizer further comprises:
a first DAC, configured to perform the digital-to-analog conversion operation on the first output signal and the second output signal to generate the first signal.

5. The equalizer of claim 4, wherein the first signal and the second signal are AC-coupled signals.

6. The equalizer of claim 5, further comprising:
a first capacitor and a second capacitor, wherein the second signal passes through the first capacitor and the second capacitor to generate a first AC-coupled signal and a second AC-coupled signal;
a third capacitor and a fourth capacitor, wherein the first signal passes through the third capacitor and the fourth capacitor to generate a third AC-coupled signal and a fouth AC-coupled signal;
wherein the first summer combines the first reference signal with the first AC-coupled signal to generate the adjusted first reference signal, the second summer combines the second reference signal with the second AC-coupled signal to generate the adjusted second reference signal, the third summer combines the third reference signal with the third AC-coupled signal to generate the adjusted third reference signal, and the fourth summer combines the fourth reference signal with the fourth AC-coupled signal to generate the adjusted fourth reference signal.

7. The equalizer of claim 4, wherein the first reference signal is equal to the third reference signal, and the second reference signal is equal to the fourth reference signal.

8. The equalizer of claim 4, wherein the first slicer and the second slicer generate the first output signal and the second output signal based on a first clock signal, the third slicer and the fourth slicer generate the third output signal and the fourth output signal based on a second clock signal, and the first clock signal and the second clock signal have a same frequency but are 180 degrees out of phase.

9. The equalizer of claim 4, further comprising:
a first multiplexer, configured to output one of the first output signal and the third output signal to serve as a first multiplexer output signal; and
a second multiplexer, configured to output one of the second output signal and the fourth output signal to serve as a second multiplexer output signal.

10. The equalizer of claim 9, further comprising:
a feedback signal generation circuit, configured to receive the first multiplexer output signal and the second multiplexer output signal to generate the feedback signal.

11. An equalizer, comprising:
a summer, configured to combine an input signal with a feedback signal to generate a compensated input signal;
a first processing circuit comprising:
a first summer, configured to combine a first reference signal with a second signal to generate an adjusted first reference signal;
a first slicer, configured to compare the compensated input signal with the adjusted first reference signal to generate a first output signal;
a second summer, configured to combine a second reference signal with the second signal to generate an adjusted second reference signal; and
a second slicer, configured to compare the compensated input signal with the adjusted second reference signal to generate a second output signal;
a second processing circuit, configured to receive the compensated signal to generate a third output signal and a fourth output signal;
a third processing circuit, configured to receive the compensated signal to generate a fifth output signal and a sixth output signal;
a fourth processing circuit, configured to receive the compensated signal to generate a seventh output signal and an eighth output signal;
a digital-to-analog converter (DAC), configured to perform a digital-to-analog conversion operation on the seventh output signal and the eighth output signal.

12. The equalizer of claim 11, wherein the second signal is an AC-coupled signal.

13. The equalizer of claim 11, wherein the summer is a current mode logic (CML) summer.

14. The equalizer of claim 11, wherein the second processing circuit comprises:
a third summer, configured to combine a third reference signal with a first signal to generate an adjusted third reference signal;
a third slicer, configured to compare the compensated input signal with the adjusted third reference signal to generate the third output signal;
a fourth summer, configured to combine a fourth reference signal with the first signal to generate an adjusted fourth reference signal; and
a fourth slicer, configured to compare the compensated input signal with the adjusted fourth reference signal to generate the fourth output signal;
wherein the equalizer further comprises:
a first DAC, configured to perform the digital-to-analog conversion operation on the first output signal and the second output signal to generate the first signal.

15. The equalizer of claim 14, wherein the third processing circuit comprises:
a fifth summer, configured to combine a fifth reference signal with a second signal to generate an adjusted fifth reference signal;
a fifth slicer, configured to compare the compensated input signal with the adjusted fifth reference signal to generate the fifth output signal;
a sixth summer, configured to combine a sixth reference signal with the second signal to generate an adjusted sixth reference signal; and
a sixth slicer, configured to compare the compensated input signal with the adjusted sixth reference signal to generate the sixth output signal;
wherein the equalizer further comprises:
a second DAC, configured to perform the digital-to-analog conversion operation on the third output signal and the fourth output signal to generate the second signal.

16. The equalizer of claim 15, wherein the fourth processing circuit comprises:
a seventh summer, configured to combine a seventh reference signal with a third signal to generate an adjusted seventh reference signal;
a seventh slicer, configured to compare the compensated input signal with the adjusted seventh reference signal to generate the seventh output signal;
an eighth summer, configured to combine an eighth reference signal with the third signal to generate an adjusted eighth reference signal; and
an eighth slicer, configured to compare the compensated input signal with the adjusted eighth reference signal to generate the eighth output signal;
wherein the equalizer further comprises:
a third DAC, configured to perform the digital-to-analog conversion operation on the fifth output signal and the sixth output signal to generate the third signal.

17. The equalizer of claim 16, wherein the first signal, the second signal, the third signal and the fourth signal are AC-coupled signals.

18. The equalizer of claim 16, wherein the first slicer and the second slicer generate the first output signal and the second output signal based on a first clock signal, the third slicer and the fourth slicer generate the third output signal and the fourth output signal based on a second clock signal, the fifth slicer and the sixth slicer generate the fifth output signal and the sixth output signal based on a third clock signal, and the seventh slicer and the eighth slicer generate the seventh output signal and the eighth output signal based on a fourth clock signal, wherein the first clock signal, the second clock signal, the third clock signal and the fourth clock signal have different phases.
